(19) United States
(12) Patent Application Publication
(10) Pub. No.: US 2015/0300579 A1
(43) Pub. Date: Oct. 22, 2015

(54) LED Bulb Lamp Capable of Realizing Wide-Angle Luminescence

(71) Applicants: SHANGHAI SANSI ELECTRONIC ENGINEERING CO., LTD., Shanghai (CN); SHANGHAI SANSI SCIENCE AND TECHNOLOGY DEVELOPMENT CO., LTD.\, Shanghai (CN); JIASHAN SANSI PHOTOELECTRIC TECHNOLOGY CO., LTD, Jiaxing City, Zhejiang (CN)

(72) Inventors: Huafeng Wang, Shanghai (CN); Peng Wang, Shanghai (CN); Li Xu, Shanghai (CN); Min Chen, Shanghai (CN)

(21) Appl. No.: 14/648,761

(22) PCT Filed: Nov. 20, 2013
(86) PCT No.: PCT/CN2013/087475

§ 371 Date: Jun. 1, 2015

(30) Foreign Application Priority Data
Dec. 4, 2012 (CN) 201220660444.4

(51) Int. Cl. F21K 99/00; F21V 29/71; F21V 17/10; F21V 1/00

(52) U.S. Cl. CPC F21K 9/58; F21V 1/00; F21V 29/717; F21V 17/108; F21Y 2101/02

(57) ABSTRACT

An LED (Light-Emitting Diode) bulb lamp realizing wide-angle luminescence includes LEDs, a heat sink and a lampshade. The heat sink is divided into a lower part which is connected with a lamp cap of a lighting fixture, and an upper part which takes a shape of a small-top big-bottom multi-surface prismoid. An included angle between each ridge surface of the prismoid and a vertical center line of the lighting fixture is θ, wherein 10°≦θ≦25°. The upper part and the lower part of the heat sink are communicated to each other. At least one LED is arranged on each ridge surface, and the upper part of the heat sink is covering in the lampshade. The LED bulb lamp enlarges light rays in a small-angle irradiation range to the most of region of a bulb, achieves an entire light distribution effect and satisfies requirements on characteristics of luminescence and heat dissipation efficiency.

### CROSS REFERENCE OF RELATED APPLICATION

This is a U.S. National Stage under 35 U.S.C 371 of the International Application PCT/CN2013/087475, filed Nov. 20, 2013, which claims priority under 35 U.S.C. 119(a-d) to CN 201220660444.4, filed Dec. 4, 2012.

### BACKGROUND OF THE PRESENT INVENTION

1. Field of Invention

The present invention relates to the LED (Light-Emitting Diode) lighting field, and more specifically to an LED bulb lamp realizing wide-angle luminescence.

2. Description of Related Arts

With LED being applied increasingly in the lighting field, the bulb lamp taking LED as the light source is gradually replacing the traditional tungsten filament lighting lamp. However, due to the features of LED, the light-emitting angle is limited to certain range. Therefore, the application of the luminaire taking LED as the light source is greatly restricted and it is necessary to do light distribution again with other optical components before daily lighting need can be met. As a LED bulb lamp, it is usually required that the wider the angle range of illumination is, the better it will be. At the same time, the higher that uniformity of illuminating light is, the better it will be. Therefore, it is imperative to design the LED bulb lamp in respect of structure and optical side to expand the angle and range of illumination and satisfy the need of people for illumination.

Energy Star (ES) in USA raised a standard, that is, for class A bulbs (i.e. standard incandescent lamp shape bulb), the following requirements are also available for the light-emitting properties in addition to such basic photoelectric property requirements as light flux output, light effect, etc.: the light intensity change in γ0-135° cannot exceed 20% of the average light intensity in that range and the light flux in γ135-180° cannot be lower than 5% of the total light flux. Very few of the Class A LED bulb products available on market currently can meet the ES standard. The most principal reason is that the light-emitting property with the above light-emitting angle cannot be met.

### SUMMARY OF THE PRESENT INVENTION

For the problems presented in the prior art, the present invention provides an LED bulb lamp which has advantages of being capable of enlarging light rays in a small-angle irradiation range to the most of a region of a bulb, achieving an entire light distribution effect and giving consideration to requirements on characteristics of luminescence and heat dissipation efficiency.

To achieve the above goal, the present invention adopts the following technical scheme.

An LED bulb lamp capable of realizing wide-angle luminescence comprises LEDs, a heat sink and a lampshade. The heat sink is divided into two parts, wherein a lower part of the heat sink is connected with a lamp cap of a lighting fixture; and, an upper part of the heat sink takes a shape of a small-top big-bottom multi-surface prismoid. An included angle theta between each ridge surface of the prismoid and a vertical center line of the lighting fixture is greater than or equal to 10 degrees and less than or equal to 25 degrees. The upper part and the lower part of the heat sink are communicated to each other. At least one LED is arranged on each ridge surface, and the upper part of the heat sink is arranged in the lampshade in a covering manner.

According to an exemplary embodiment of the invention, the multi-surface prismoid is a six-sided prismoid.

According to an exemplary embodiment of the invention, the LED is arranged on the ridge surface of a position near the lower part of the heat sink.

According to an exemplary embodiment of the invention, four LEDs are arranged on each ridge surface.

According to an exemplary embodiment of the invention, the included angle theta between each ridge surface of the prismoid and the vertical center line of the lighting fixture is 20 degrees.

According to an exemplary embodiment of the invention, a through-hole is provided on a top of the lampshade; the top of the lampshade and a top surface of the prismoid are connected by a connector running through from top to bottom; multiple convection heat dissipation channels are formed between the lampshade, the upper part of the heat sink and hollow parts formed on the lower part of the heat sink.

According to an exemplary embodiment of the invention, the connector is a press type ring having a barb structure. After the connector is installed in place, the barb structure is ejected out and hooks a top of the upper part of the heat sink to play a role of fixing the lampshade.

According to an exemplary embodiment of the invention, the lampshade is coated with diffusion material having a fog level of 95%-99% and transmissivity over 50%.

According to an exemplary embodiment of the invention, the upper and lower parts of the heat sink are an integrated type and the lower part of the heat sink is hollow structure.

The technical scheme adopted by the present invention sets an installation surface on which an LED light source is installed to the shape of the multi-surface prismoid, and designs the number of the ridge surfaces for installing LED and the included angle theta of each ridge surface according to a requirement of a lamp light-emitting angle. To achieve the entire light distribution effect, the angle theta between each ridge surface of the prismoid and the vertical center line of the lighting fixture is greater than or equal to 10 degrees and less than or equal to 25 degrees. At the same time, with a heat dissipation problem being considered, the upper part and the lower part of the heat sink are communicated to each other to increase the heat dissipation efficiency through air convection; a location where each LED is arranged on each ridge surface is kept as close to a lower end of the prismoid as possible. Problems of power and light flux are solved by setting the number of LEDs and coating the diffusion material on the lampshade for even and soft luminescence, wherein the diffusion material has the fog level of 95%-99% and the transmissivity over 50%.

### BRIEF DESCRIPTION OF THE DRAWINGS

FIG. 1 is a structural sketch view of an LED bulb lamp capable of realizing wide-angle luminescence according to a preferred embodiment of the present invention;

FIG. 2 is a cross-sectional view of FIG. 1.

### DETAILED DESCRIPTION OF THE PREFERRED EMBODIMENT

The technical scheme of the present invention will be described in further detail below in combination with figures and embodiment.

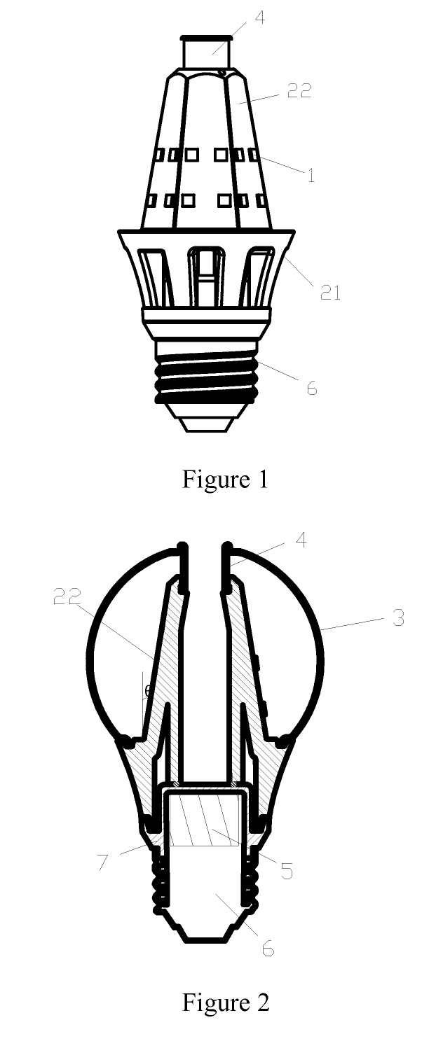

As shown in FIG. 1 and FIG. 2, an LED bulb lamp in a preferred embodiment of the present invention comprises LEDs 1, a heat sink and a lampshade 3. The heat sink is in ceramic material and divided into two parts as an integrated structure. A lower part 21 is hollow structure and an upper part 22 takes a shape of a small-top big-bottom multi-surface prismoid. The upper and lower parts 21, 22 of the heat sink 2 connect with each other. Each ridge surface has four LEDs 1 installed thereon. The lampshade 3 is covered in the upper part 22 of the heat sink. The more ridge surfaces of the prismoid are, the easier the requirement for full light distribution requirement can be achieved. However, the more aluminum base plates required by lamp to install LED will be needed for the production process to become more complicated. Under the circumstance of considering the above factors comprehensively, the preferred embodiment selects a prismoid shape with six surfaces, and an angle theta θ between each ridge surface of the prismoid and a vertical center line of a lighting fixture is greater than or equal to 10 degrees and less than or equal to 25 degrees. In the preferred embodiment of the present invention, the inclination angle theta θ between the ridge surface of the prismoid shape with six surfaces and the vertical center line of the lighting fixture is 20 degrees.

Through experimental test, locations where multiple LEDs 1 are arranged on each ridge surface of the prismoid do not have a great influence on light distribution. However, considering heat dissipation, LEDs 1 should be arranged as close to the lower part 21 of the heat sink as possible, so that heat produced by the LEDs can be dissipated very quickly through the hollow structure in the lower part 21 of the heat sink.

In order to dissipate heat through air convection, the lampshade 3 is in a structure with a through-hole cut on a top. The top of the lampshade 3 and a top surface of the upper part 22 of the heat sink are connected by a connector 4 running through from top to bottom; multiple convection heat dissipation channels are formed between the lampshade 3, the upper part 22 of the heat sink and hollow parts formed on the lower part 21 of the heat sink. The connector 4 is a press type ring in a barb structure. When the connector 4 is installed in place, the barb structure is ejected out and hooks a top of the upper part 22 of the heat sink to play a role of fixing the lampshade 3.

A power supply 5 is installed in a power supply installation cavity 7 provided in a lamp cap 6 of the lighting fixture.

The lampshade 3 is coated with diffusion material thereon. To avoid influence on the light effect and light distribution, there are property requirements for the diffusion material. It is required that a fog level is 95%-99% and a transmissivity is over 50%. In coating the diffusion material, one or multiple layers of coating can be applied according to actual need.

One skilled in the art will understand that the embodiment of the present invention as shown in the drawings and described above is exemplary only and not intended to be limiting. It will thus be seen that the objects of the present invention have been fully and effectively accomplished. Its embodiments have been shown and described for the purposes of illustrating the functional and structural principles of the present invention and is subject to change without departure from such principles. Therefore, the present invention includes all modifications encompassed within the spirit and scope of the following claims.

What is claimed is:

1. An LED bulb lamp capable of realizing wide-angle luminescence, comprising: LEDs, a heat sink and a lampshade, wherein the heat sink is divided into two parts, wherein a lower part of the heat sink is connected with a lamp cap of a lighting fixture and an upper part of the heat sink takes a shape of a small-top big-bottom multi-surface prismoid; an included angle theta between each ridge surface of the prismoid and a vertical center line of the lighting fixture is greater than or equal to 10 degrees and less than or equal to 25 degrees; the upper part and the lower part of the heat sink are communicated to each other; at least one LED is arranged on each ridge surface; and the upper part of the heat sink is arranged in the lampshade in a covering manner.

2. The LED bulb lamp of claim 1, wherein the multi-surface prismoid is a six-sided prismoid.

3. The LED bulb lamp of claim 1, wherein the LED is arranged on the ridge surface of a position near the lower part of the heat sink.

4. The LED bulb lamp of claim 3, wherein four LEDs are arranged on each ridge surface.

5. The LED bulb lamp of claim 1, wherein the included angle theta between each ridge surface of the prismoid and the vertical center line of the lighting fixture is 20 degrees.

6. The LED bulb lamp of claim 1, wherein a through-hole is provided on a top of the lampshade; the top of the lampshade and a top surface of the prismoid are connected by a connector running through from top to bottom; and, multiple convection heat dissipation channels are formed between the lampshade, the upper part of the heat sink and hollow parts formed on the lower part of the heat sink.

7. The LED bulb lamp of claim 6, wherein the connector is a press type ring having a barb structure; after the connector is installed in place, the barb structure is ejected out and hooks a top of the upper part of the heat sink to play a role of fixing the lampshade.

8. The LED bulb lamp of claim 1, wherein the lampshade is coated with diffusion material having a fog level of 95%-99% and a transmissivity over 50%.

9. The LED bulb lamp of claim 1, wherein the upper and lower parts of the heat sink are an integrated type; and the lower part of the heat sink is hollow structure.
